(19) United States
(12) Patent Application Publication
(10) Pub. No.: US 2020/0242747 A1
(43) Pub. Date: Jul. 30, 2020

(54) IMAGE RECOGNITION SYSTEM AND IMAGE RECOGNITION METHOD

(71) Applicant: TOKYO ELECTRON LIMITED, Tokyo (JP)

(72) Inventor: Shinjiro WATANABE, Nirasaki City (JP)

(21) Appl. No.: 16/750,336

(22) Filed: Jan. 23, 2020

(30) Foreign Application Priority Data
Jan. 29, 2019 (JP) 2019-012630

(51) Int. Cl. G06T 7/00; G06T 7/73; G06K 9/66; G06N 20/00

(52) U.S. Cl. CPC G06T 7/001; G06T 7/75; G06T 2207/20081; G06N 20/00; G06T 2207/30148; G06K 9/66

(57) ABSTRACT

An image recognition system includes: an image data collector configured to collect image data including a recognition target from a plurality of test apparatuses; a learning processor configured to perform additional machine learning based on the image data collected in the image data collector for a first model configured to recognize a characteristic portion of the recognition target; a model updater configured to update a model from the first model to a second model based on a result of the additional machine learning; a first transmitter configured to transmit the second model to a specific test apparatus; a recognition result determiner configured to receive and determine a recognition result using the second model in the specific test apparatus; and a second transmitter configured to transmit the second model to at least one of the plurality of test apparatuses in accordance with a determination result by the recognition result determiner.

### CROSS-REFERENCE TO RELATED APPLICATION

This application is based upon and claims the benefit of priority from Japanese Patent Application No. 2019-012630, filed on Jan. 29, 2019, the entire contents of which are incorporated herein by reference.

### TECHNICAL FIELD

The present disclosure relates to an image recognition system and an image recognition method.

### BACKGROUND

In a manufacturing process of a semiconductor device, an electrical test is performed on a plurality of semiconductor devices formed on a semiconductor wafer (hereafter, briefly referred to as a wafer) after all processes for the wafer are finished. In apparatuses that perform such an electrical test, generally, a probe card having a plurality of probes that is configured to be brought into contact with a semiconductor device formed on a wafer is disposed to face a stage that adsorbs, holds and supports a wafer. Further, the wafer on the stage to the probe card is pressed to the probe card, whereby the probes of the probe card are brought into contact with an electrode pad of a device, and a test is performed on the electrical characteristic in this state.

In these test apparatuses, an image recognition technology that photographs an electrode pad and recognizes needle tracks from the image has been used to check whether probes have come into contact with the electrode pad of a device (e.g., Patent Document 1).

### PRIOR ART DOCUMENT

### Patent Document

Patent Document 1: Japanese Laid-open Publication No. 2005-45194

### SUMMARY

According to one embodiment of the present disclosure, there is provided an image recognition system including: an image data collector configured to collect image data including a recognition target from a plurality of test apparatuses; a learning processor configured to perform additional machine learning based on the image data collected in the image data collector for a first model, which is obtained by previous machine learning and configured to recognize a characteristic portion of the recognition target; a model updater configured to update a model configured to recognize the characteristic portion of the recognition target from the first model to a second model on a basis of a result of the additional machine learning by the learning processor; a first transmitter configured to transmit the second model to a specific test apparatus of the plurality of test apparatuses; a recognition result determiner configured to receive and determine a recognition result of recognizing the recognition target using the second model in the specific test apparatus; and a second transmitter configured to transmit the second model to at least one of the plurality of test apparatuses in accordance with a determination result by the recognition result determiner.

### BRIEF DESCRIPTION OF DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is a block diagram schematically showing a test system including an example of an image recognition system according to a first embodiment.

FIG. 2 is a schematic configuration view showing a first test apparatus of the test system of FIG. 1.

FIG. 3 is a schematic view showing a case in which a test target device formed on a wafer is photographed by a first camera in the first test apparatus.

FIG. 4 is a schematic view showing a case in which a probe card is photographed by a second camera in the first test apparatus.

FIG. 5 is a flowchart showing an imager recognition method in an image recognition system 100 according to the first embodiment.

FIG. 6A is a view showing an example of an image when a recognition target of image recognition is a needle track of a probe.

FIG. 6B is a view showing an example of an image when a recognition target of image recognition is a needle track of a probe.

FIG. 7A is a view showing an example of an image when a recognition target of image recognition is a needle tip of a probe.

FIG. 7B is a view showing an example of an image when a recognition target of image recognition is a needle tip of a probe.

FIG. 7C is a view showing an example of an image when a recognition target of image recognition is a needle tip of a probe.

FIG. 7D is a view showing an example of an image when a recognition target of image recognition is a needle tip of a probe.

FIG. 7E is a view showing an example of an image when a recognition target of image recognition is a needle tip of a probe.

FIG. 7F is a view showing an example of an image when a recognition target of image recognition is a needle tip of a probe.

FIG. 7G is a view showing an example of an image when a recognition target of image recognition is a needle tip of a probe.

FIG. 8 is a block diagram showing another example of an image recognition system according to the first embodiment.

FIG. 9 is a block diagram schematically showing a test system including an example of an image recognition system according to a second embodiment.

FIG. 10 is a flowchart showing an imager recognition method in an image recognition system according to the second embodiment.

FIG. 11 is a block diagram showing another example of an image recognition system according to the second embodiment.

FIG. 12 is a block diagram showing an example of an image recognition system according to a third embodiment.

FIG. 13 is a block diagram showing another example of an image recognition system according to the third embodiment.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

Hereinafter, embodiments of the present disclosure will be described with reference to the accompanying drawings.

### First Embodiment

First, a first embodiment is described.

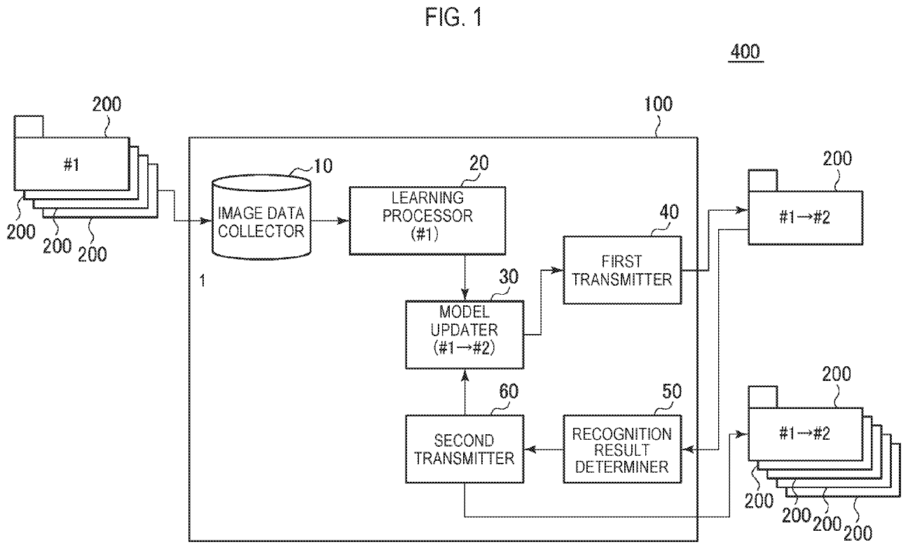

FIG. 1 is a block diagram schematically showing a test system including an example of an image recognition system according to a first embodiment.

The test system 400 includes a plurality of first test apparatuses 200 disposed in, for example, a factory, and an image recognition system 100 to improve a recognition level of recognition targets of the first test apparatuses 200 for image data including the recognition targets.

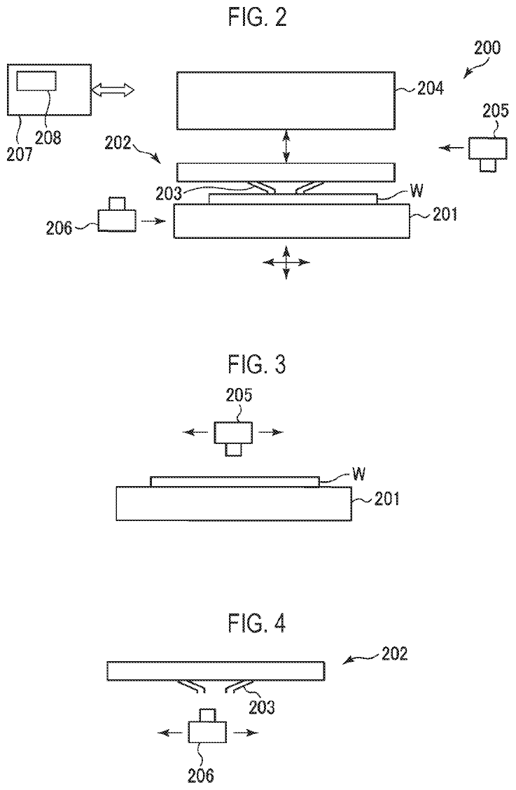

The first test apparatus 200, as shown in FIG. 2 for example, includes a stage 201 that adsorbs, holds and supports a wafer W, a probe card 202 having a plurality of probes 203, a tester 204, a first camera 205, a second camera 206, and a controller 207.

The stage 201 can be aligned in a plane direction and an up-down direction by an aligner (not shown) and brings the probes 203 into contact with a plurality of test target devices formed on a wafer W, whereby an electrical test is performed by the tester 204. The first test apparatus 200 may perform a test by scanning a wafer W such that the probes 203 relatively scan the wafer W, and may perform a test by simultaneously bringing a plurality of probes into contact with a plurality of test target devices formed on a wafer W. The first test apparatus 200 may be a single test apparatus or may be a test apparatus having a plurality of test parts.

The first camera 205 is movable and is configured to photograph test target devices formed on a wafer W, as shown in FIG. 3. The second camera 206 is also movable and is configured to photograph the probe card 202, as shown in FIG. 4. Accordingly, image data including recognition targets that is needed for a test are obtained. The recognition targets, for example, may be an electrode pad, needle track when the probes 203 come into contact with an electrode pad of a device during a test, the shape of the needle tip of the probes 203 and so on. These recognition targets are recognized by an image recognizer 208 of the controller 207. Recognizing the shape of an electrode pad is needed to align probes with the electrode pad, recognizing a needle tip is needed to determine a center position, and recognizing a needle track is needed to check that a probe has come into contact with the electrode pad of a device.

In the first test apparatus 200, for the recognition targets, the image recognizer 208 of the controller 207 is equipped with software that recognizes the recognition targets from image data using a model that is obtained in advance by machine learning to recognize characteristic portions of the recognition targets. The model can be updated by additional machine learning to be described below.

Machine learning means a technology and method that makes a computer, etc. perform the function of learning as humans naturally do. Deep learning may be appropriately used as the machine learning. Deep learning is a method of machine learning that uses a multi-layer neural network constructed by hierarchically connecting a plurality of processing layers. The model that is used in this case is a numerical formula, a plurality of parameters exists in the numerical formula, and the model can be changed by the values of the parameters or by giving weights. In this embodiment, the model in an initial state of the image recognizer 208 of the first test apparatus 200 is a first model #1.

The image recognition system 100, as shown in FIG. 1, includes an image data collector 10, a learning processor 20 that performs machine learning, a model updater 30, a first transmitter 40, a recognition result determiner 50, and a second transmitter 60.

The image data collector 10 collects image data including the recognition targets described above from the first test apparatuses 200. The image data that the image data collector 10 collects has only to be image data that could not be recognized by the image recognizers 208 of the first test apparatuses 200.

The learning processor 20 performs additional machine learning based on the image data collected in the image data collector 10 on a first model (the same as the first models #1 of the first test apparatuses 200) that is obtained by previous machine learning to recognize characteristic portions of the recognition targets. Deep learning described above is generally used as the machine learning in this case. Machine learning by the learning processor 20 may be automatically performed at an appropriate timing. Machine learning may be periodically performed or may be performed at a point in time when the data in the image data collector 10 reaches a predetermined amount. Machine learning may be performed by operation by an operator.

The model updater 30 updates the model for recognizing characteristic portions of the recognition targets from a first model #1 to a second model #2 on the basis of the result of the machine learning by the learning processor 20. The second model may be a model that can recognize image data from which the recognition targets could not be recognized in the first model, and then has a higher recognition level.

The learning processor 20 and the model updater 30 may be integrated.

The first transmitter 40 receives an updated second model from the model updater 30 and transmits the second model to a specific first test apparatus 200 of the plurality of first test apparatuses 200. The specific first test apparatus 200 performs recognition evaluation for the recognition targets of the image data from which the recognition targets could not be recognized in the first model, using the second model.

The recognition result determiner 50 receives and determines the recognition result of the recognition targets, of which recognition is performed using the second model in the specific first test apparatus 200, of image data which are similar to or same as image data from which the recognition targets could not be recognized in the first model.

The second transmitter 60 transmits the second model to first test apparatuses 200 other than the specific first test apparatus in accordance with the determination result by the recognition result determiner 50. In more detail, the second transmitter 60 transmits the second model to the first test apparatuses 200 when the recognition result determiner 50 determines that the recognition result is satisfactory.

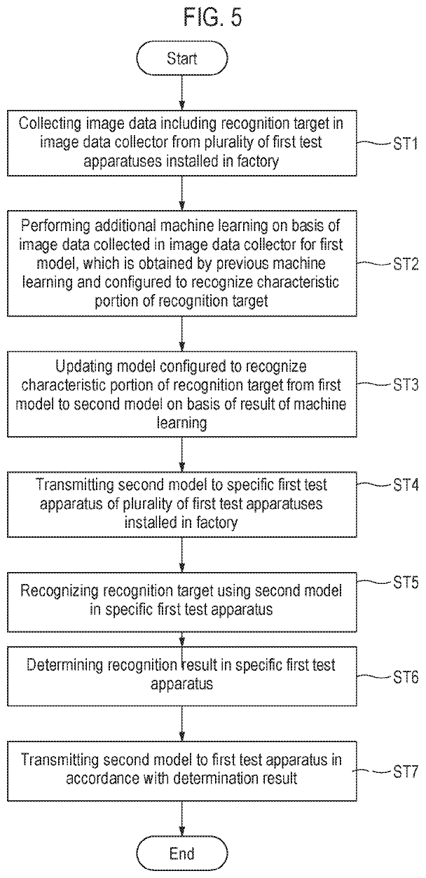

Next, an image recognition method in the image recognition system 100 according to the first embodiment is described. FIG. 5 is a flowchart showing an imager recognition method in an image recognition system 100 according to the first embodiment.

First, image data including the recognition targets are collected into the image data collector 10 from a plurality of test apparatuses 200 installed in a factory (ST1). The image data may be ones that could not be recognized by the image recognizers 208 of the first test apparatuses 200.

Next, the learning processor 20 performs additional machine learning on a first model, which is obtained in previous machine learning to recognize characteristic portions of the recognition targets, on the basis of the image data collected in the image data collector 10 (ST2). Deep learning described above is generally used as the machine learning in this case.

Next, the model updater 30 updates the model for recognizing characteristic portions of the recognition targets from the first model to a second model on the basis of the result of the machine learning (ST3).

Next, the second model is transmitted to a specific first test apparatus of the plurality of first test apparatuses 200 installed in the factory (ST4).

Next, recognition evaluation is performed for the recognition targets using the second model in the specific first test apparatus 200 (ST5).

Next, the recognition result performed in the specific first test apparatus is determined (ST6).

Next, the second model is transmitted from the second transmitter 60 to the first test apparatuses 200 on the basis of the determination result in ST6 (ST7). In detail, when it is determined that the recognition result is satisfactory by the recognition result determiner 50 in ST6, the models of the image recognizers of all the test apparatuses 200 are updated to second models by transmitting the second model to all the first test apparatuses 200 in the factory.

If the recognition result in the specific first test apparatus 200 is not satisfactory, updating to the second model is stopped. Although only recognition evaluation for the second model in the specific first test apparatus 200 is performed in ST5 in the above embodiment, the model of the first test apparatus 200 may be updated to the second model in ST5. In this case, when it is determined that the recognition result is satisfactory by the recognition result determiner 50 in ST6, the second model is transmitted to the first test apparatuses 200 other than the specific first test apparatus 200 in ST7.

As described above, according to the image recognition system 100 of this embodiment, image data including the recognition targets are collected into the image data collector 10 from a plurality of first test apparatuses 200 installed in the factory. For the first model, additional machine learning is performed on the basis of the collected image data and the model is updated from the first model to the second model. After the recognition result of the second model in the specific first test apparatus 200 is recognized, the models of all the first test apparatuses 200 in the factory are replaced with the second model. Accordingly, it is possible to always recognize the recognition targets on the basis of a newly updated model in all the first test apparatuses 200 in the factory. Therefore, even if image recognition is not accurately performed on a recognition target, it is possible to efficiently recognize the recognition target within a short time. Further, it is possible to recognize the recognition target without leaking information out of the factory.

In the related art, as described in Patent Document 1, the recognition targets such as a needle track were photographed by a camera and recognized as images. However, updating software for performing image recognition on the recognition targets is not described in Patent Document 1.

In general, in such type of image recognition for the recognition targets, for example, when a new device is tested or when a recognition target is changed by a change according to a lapse of time, whether there is dust, a difference in contrast, etc., it is impossible to deal with this situation with the existing software, so a faulty recognition result in which image recognition is not accurately performed occurs.

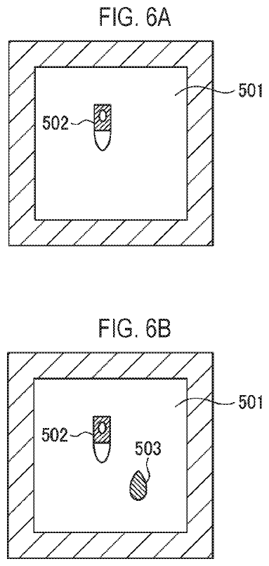

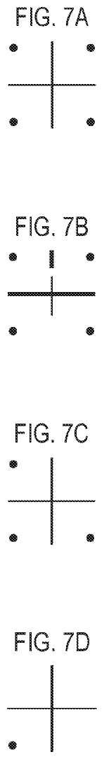

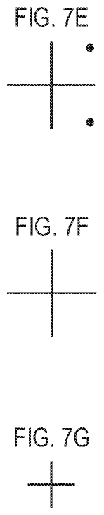

For example, when a recognition target is a needle track, if there is dust 503 other than the needle track 502, as shown in FIG. 6B, even though software can recognize a needle track 502 formed on an electrode pad 501 as a needle track in the image shown in FIG. 6A, it is impossible to accurately recognize the needle track, so a faulty recognition result may occur. Further, when a recognition target is a needle tip, generally, even though it is the shape shown in FIG. 7A, some portions may disappear from the image due to a lapse of time or a difference in contrast, as shown in FIGS. 7B to 7G for example. Further, various types occur in the image such as local thinning or enlargement of a specific portion due to wear at the tip. Accordingly, the recognition result easily becomes faulty. The shape of the electrode of a new device may be changed in some cases, and in this case, the electrode pad cannot be recognized as an electrode pad.

In the related art, when this situation occurs and a faulty recognition result is obtained, people involved with the fields of service and technique need to do even examination of a reform measure, and design, construction, evaluation, and installation of software including collection of images. Further, it takes long time to operate improved software after a faulty recognition result is obtained.

However, in the image recognition system 100 according to this embodiment, as described above, even if image recognition is not accurately performed on a recognition target, it is possible to efficiently recognize the recognition target within a short period by machine learning. Further, since it is possible to recognize a recognition target without leaking information out of the factory, it is possible to obtain an effect of preventing information leakage. Further, it is possible to recognize the recognition targets by the same model for all first test apparatuses 200 in the factory and it is possible to recognize the recognition targets at the same level in the factory.

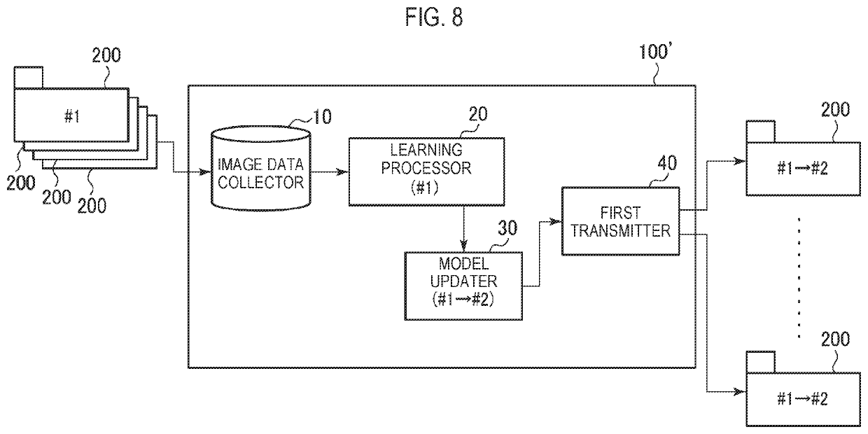

Further, as a modified example of the image recognition system 100, as shown in FIG. 8, it may be possible to consider an image recognition system 100′ having a function that updates a model to a second model by a model updater 30 and then only transmits the second model without specifying a test apparatus that transmits a model to a plurality of first test apparatuses 200. In this case, when the recognition result is faulty in the first test apparatus 200, it is possible to deal with this case by separately providing a device returning the model into the first model or by making an operator return the model into the first model.

### Second Embodiment

Next, a second embodiment is described.

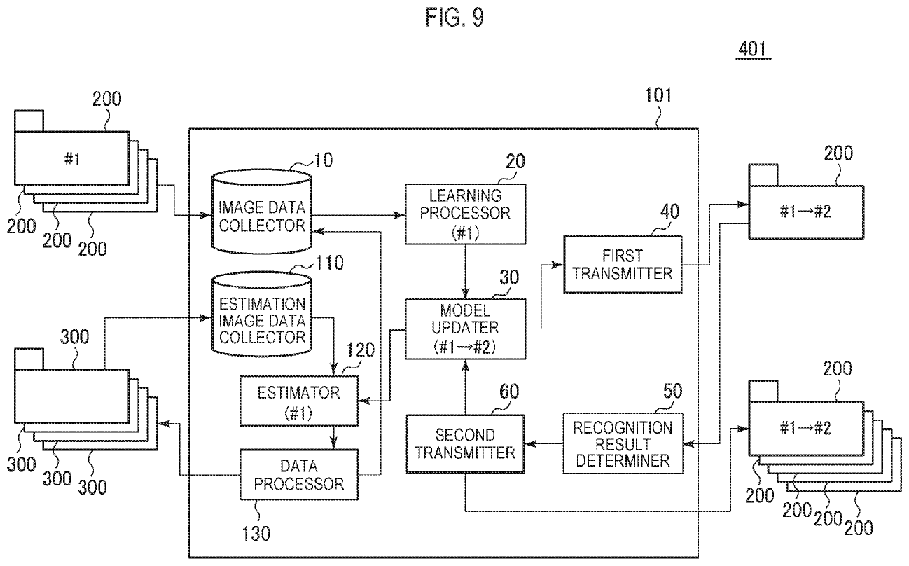

FIG. 9 is a block diagram schematically showing a test system including an example of an image recognition system according to a second embodiment.

The test system 401 includes the plurality of first test apparatuses 200 disposed in, for example, a factory, one or more second test apparatuses 300, and an image recognition system 101 for improving a recognition level of the recognition targets of the first test apparatuses 200 and the second test apparatuses 300 from image data including the recognition targets.

The second test apparatuses 300 are the same in fundamental configuration as the first test apparatuses 200), but are different from the first test apparatuses 200 in that the software of the image recognizer does not use a model obtained by machine learning to recognize characteristic portions of the recognition targets.

The image recognition system 101 according to this embodiment, as shown in FIG. 9, includes an image data collector 10, a learning processor 20 that performs machine learning, a model updater 30, a first transmitter 40, a recognition result determiner 50, a second transmitter 60, an estimation image data collector 110, an estimator 120, a data processor 130.

The learning processor 20, the model updater 30, the first transmitter 40, the recognition result determiner 50, and the second transmitter 60 are configured in the same way as the first embodiment.

The estimation image data collector 110 collects image data including the recognition targets from the first test apparatuses 300. The image data that the estimation image data collector 110 collects has only to be image data that could not be recognized by the image recognizers of the second test apparatuses 300.

The estimator 120 receives image data including the recognition targets from the estimation image data collector 110 and estimates the recognition targets for the image data. In detail, the estimator 120 estimates the recognition targets using the first model described above.

The software of the image recognizer does not use a model for recognizing characteristic portions of the recognition targets, so the second test apparatuses 300 estimates the recognition targets using a first model by the estimator 120, similar to the first test apparatuses 200. The estimator 120 can receive information from the model updater 30 and update the first model to a second model. Accordingly, the estimator 120 can estimate the recognition targets using the second model.

The data processor 130 transmits the result of estimating (recognizing) the recognition targets by the estimator 120 to the second test apparatus 300 of a transmission source of image data. When the estimator 120 fails to estimate (recognize) a recognition target, the data processor 130 transmits the estimation result of the recognition target to the second test apparatus 300 of a transmission source of image data and accumulates the image data in the image data collector 10. The estimation result that is transmitted to the second test apparatus 300 is numerical data (the position, size, etc. of a needle track when a recognition target is a needle track). When the estimator 120 can estimate (recognize) the recognition targets, the image data is deleted from the estimation image data collector 110.

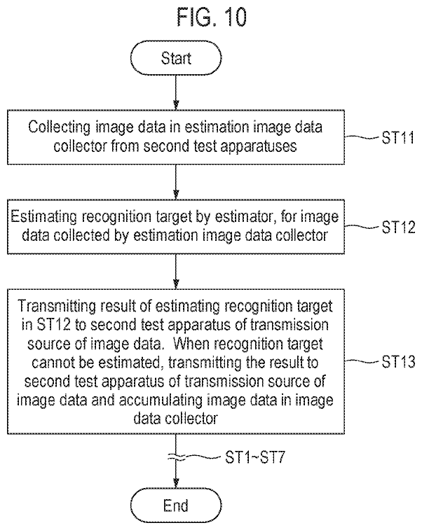

Next, an image recognition method in the image recognition system 101 according to the second embodiment is described. FIG. 10 is a flowchart showing an imager recognition method in an image recognition system 101 according to the second embodiment.

Image data are collected into the estimation image data collector 110 from the second test apparatuses 300 installed in the factory (ST11). The image data that are collected in this case has only to be image data that could not be recognized by the image recognizers of the second test apparatuses 300.

The estimator 120 estimates the recognition targets for the image data collected by the estimation image data collector 110 (ST12). In this process, it is possible to estimate the recognition targets using the first model described above. Accordingly, recognition of the recognition targets of the second test apparatuses 300 can be performed with the same level as that of the first test apparatuses 200. When the model updater 30 has updated the model from a first model to a second model, ST12 can be performed by receiving information from the model updater 30 and updating the first model to the second model.

When the recognition target can be estimated in ST12, the result is transmitted to the second test apparatus 300 of a transmission source of image data. When the recognition target cannot be estimated, the result is transmitted to the second test apparatus 300 of a transmission source of image data and the image data is accumulated in the image data collector 10 (ST13). Accordingly, it is possible to collect image data for model update even from the second test apparatus 300. The factor that is transmitted to the second test apparatus 300 in ST13 is numerical data (the position, size, etc. of a needle track when a recognition target is a needle track). When the recognition target can be estimated, the image data is deleted from the estimation image data collector 110.

In this embodiment, other than these processes, ST1 to ST7 of the first embodiment are performed. ST11 to ST13 are described over ST1 to ST7 in FIG. 10, but the order of ST1 to ST7 and ST11 to ST13 is not limited thereto, and ST1 to ST7 may be performed first, or ST1 to ST7 and ST11 to ST13 may be simultaneously performed.

According to the image recognition system 101 of this embodiment, similar to the image recognition system 100 of the first embodiment, the models of all the first test apparatuses 200 are replaced with second models by collection of image data including the recognition targets in the image data collector 10, additional machine learning, and model update. Accordingly, it is possible to always recognize the recognition targets on the basis of a newly updated model in all the first test apparatuses 200 in the factory. Therefore, even if image recognition is not accurately performed on a recognition target, it is possible to efficiently recognize the recognition target within a short time without leaking information out of the factory. Further, even if there is a second test apparatus 300 that does not use a model obtained by machine learning in the factory, it is possible to make a recognition level for the recognition targets be a level close to the case of only the first test apparatuses 200. Further, in the second test apparatuses 300, even the image data including the recognition targets, which could not be estimated by the estimator 120, are collected in the image data collector 10 and used as image data for additional machine learning, thereby being able to contribute to upgrading a model.

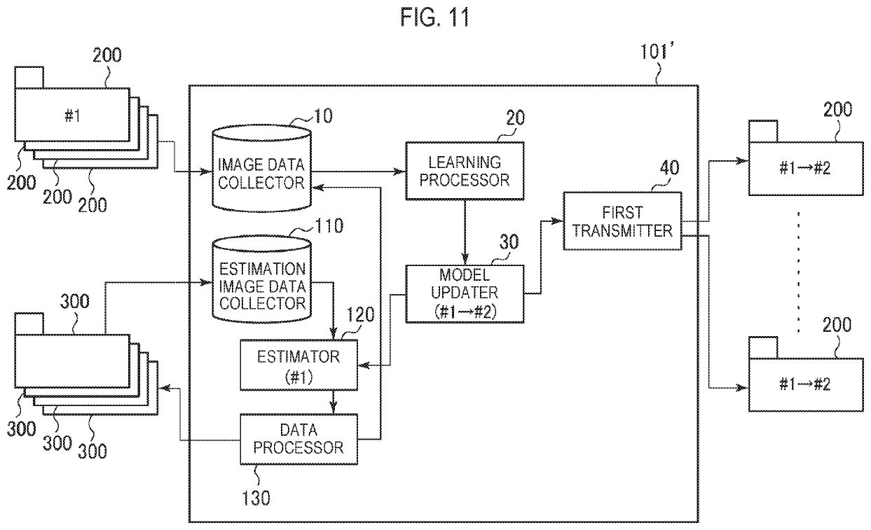

Further, as a modified example of the image recognition system 101, as shown in FIG. 11, it may be possible to consider an image recognition system 101′ having a function that updates a model to a second model by a model updater 30 and then only transmits the second model without specifying a test apparatus that transmits a model to a plurality of first test apparatuses 200. In this case, when the recognition result is faulty in the first test apparatus 200, it is possible to deal with this case by separately providing a device returning the model into the first model or by making an operator return the model into the first model.

### Third Embodiment

Next, a third embodiment is described.

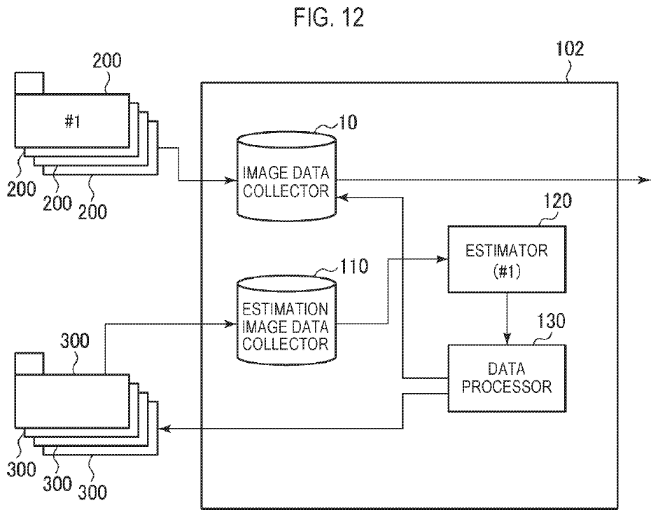

FIG. 12 is a block diagram showing an example of an image recognition system according to a third embodiment. In this embodiment, similar to the second embodiment, there are first test apparatuses 200 and second test apparatuses 300 as test apparatuses.

An image recognition system 102 according to this embodiment, as shown in FIG. 12, includes an image data collector 10, an estimation image data collector 110, an estimator 120, and a data processor 130. That is, the image recognition system 102 is obtained by removing the learning processor 20, the model updater 30, the first transmitter 40, the recognition result determiner 50, and the second transmitter 60 from the image recognition system 101 of the second embodiment.

In the image recognition system 102 according to this embodiment, similar to the image recognition system 101 according to the second embodiment, image data are collected into the estimation image data collector 110 from the second test apparatuses 300 installed in the factory. The image data that are collected in this case has only to be image data that could not be recognized by the image recognizers of the second test apparatuses 300. The estimator 120 estimates the recognition targets for the image data collected by the estimation image data collector 110 using the first model described above. The data processor 130 transmits the estimation result for the recognition targets to the second test apparatus 300 that is a transmission source of image data. When the estimator 120 fails to estimate (recognize) a recognition target, the data processor 130 transmits the estimation result to the second test apparatus 300 of a source of image data and accumulates the image data in the image data collector 10. Image data from which a recognition target could not be recognized are collected in the image data collector 10 even from the first test apparatuses 200.

Accordingly, as test apparatuses in the factory, when there is a first test apparatus 200 that uses machine learning using a first model and a second test apparatus 300 that does not use machine learning, the second test apparatus 300 can also recognize the recognition targets with the same level as that of the first test apparatus 200. Further, image data from which a recognition target could not be recognized by the first model can be accumulated in the image data accumulator 10 from both of the first test apparatus 200 and the second test apparatus 300. Accordingly, the image data are provided to a separately provided machine learning processor, whereby it is possible to update a model and improve the recognition level for the recognition targets.

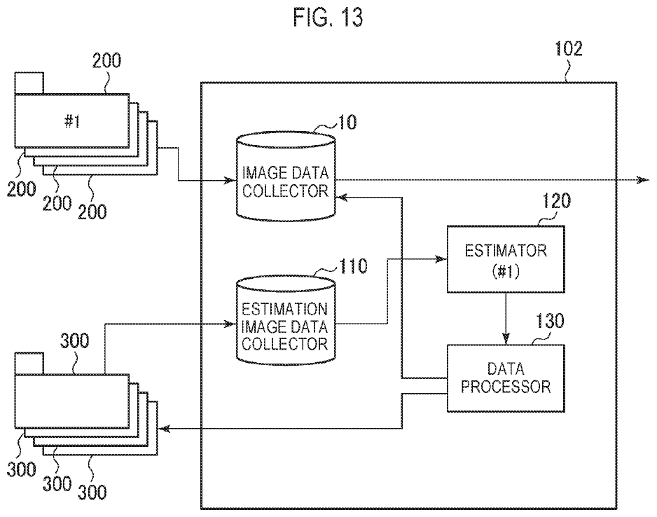

Further, an image recognition system 103 shown in FIG. 13 is similar in configuration to the image recognition system 120, but the test apparatuses in the factory are all second test apparatuses 300 in this case. In this case, similarly, the second test apparatuses 300 can recognize the recognition targets with the same level as that of the first test apparatus 200. Further, image data from which recognition targets could not be recognized by the first model can be accumulated in the image data collector 10 from the second test apparatuses 300. Accordingly, the image data are provided to a separately provided machine learning processor, whereby it is possible to update a model and improve the recognition level for the recognition targets.

Although embodiments were described above, the embodiments disclosed herein should be construed as only examples, not limiting, in all terms. The above embodiments may be omitted, replaced, and changed in various ways without departing from the accompanying claims and the subject thereof.

For example, the test apparatuses of the embodiments are only examples and any test apparatus can be applied as long as it includes an operation that recognizes the recognition target by image recognition.

Further, although an electrode pad, needle tracks formed on an electrode pad by probes, and needle tips of probes were exemplified as the recognition targets in the embodiments described above, the recognition targets are not limited thereto.

According to the present disclosure, there are provided an image recognition system and an image recognition method that can recognize the recognition targets within a short period even if image recognition is not accurately performed on the recognition target such as a needle track in test apparatuses in, for example, a factory.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. An image recognition system comprising:
an image data collector configured to collect image data including a recognition target from a plurality of test apparatuses;
a learning processor configured to perform additional machine learning on a basis of the image data collected in the image data collector for a first model, which is obtained by previous machine learning and configured to recognize a characteristic portion of the recognition target;
a model updater configured to update a model configured to recognize the characteristic portion of the recognition target from the first model to a second model on a basis of a result of the additional machine learning by the learning processor;
a first transmitter configured to transmit the second model to a specific test apparatus of the plurality of test apparatuses;
a recognition result determiner configured to receive and determine a recognition result of recognizing the recognition target using the second model in the specific test apparatus; and
a second transmitter configured to transmit the second model to at least one of the plurality of test apparatuses in accordance with a determination result by the recognition result determiner.

2. The image recognition system of claim 1, wherein image data from which the recognition result of recognizing the recognition target is faulty are collected in the image data collector.

3. The image recognition system of claim 2, wherein in the test apparatus, among the plurality of test apparatuses, to which the second model is transmitted, the model configured to recognize the characteristic portion of the recognition target is updated from the first model to the second model.

4. The image recognition system of claim 3, wherein the plurality of test apparatuses includes a first test apparatus that recognizes the recognition target using the model, which is obtained by previous machine learning and configured to recognize the characteristic portion of the recognition target, and the test apparatus, among the plurality of test apparatuses, to which the second model is transmitted is the first test apparatus.

5. The image recognition system of claim 1, wherein in the test apparatus, among the plurality of test apparatuses, to which the second model is transmitted, the model configured to recognize the characteristic portion of the recognition target is updated from the first model to the second model.

6. The image recognition system of claim 1, wherein the plurality of test apparatuses includes a first test apparatus that recognizes the recognition target using the model, which is obtained by previous machine learning and configured to recognize the characteristic portion of the recognition target, and the test apparatus, among the plurality of test apparatuses, to which the second model is transmitted is the first test apparatus.

7. The image recognition system of claim 1, further comprising:
an estimator configured to receive image data from which the recognition target could not be recognized in the test apparatuses, and estimate the recognition target for the image data; and
a data processor configured to transmit an estimation result of estimating the recognition target by the estimator to the test apparatus of a transmission source of the image data, and configured to accumulate the image data in the image data collector when the recognition target could not be estimated by the estimator.

8. The image recognition system of claim 7, wherein the plurality of test apparatuses includes a second test apparatus that does not use the model which is configured to recognize the characteristic portion of the recognition target, and
the estimator configured to receive image data from which the recognition target could not be recognized in the second test apparatus, and estimate the recognition target.

9. The image recognition system of claim 7, wherein the estimator is configured to estimate the recognition target for the image data by using the first model.

10. The image recognition system of claim 7, wherein the estimator uses the first model which is configured to be updated to the second model updated by the model updater.

11. The image recognition system of claim 1, wherein the test apparatuses are configured to perform a test of an electrical characteristic for a wafer on which a plurality of devices are formed by bringing each probe of a probe card into contact with electrode pad of the devices, and
the recognition target is at least one of the electrode pad, needle track formed on the electrode pad by the probe, and needle tip of the probe.

12. An image recognition method comprising:
collecting image data including a recognition target in an image data collector from a plurality of test apparatuses;
performing additional machine learning on a basis of the collected image data for a first model, which is obtained by previous machine learning and configured to recognize a characteristic portion of the recognition target;
updating a model configured to recognize the characteristic portion of the recognition target from the first model to a second model on a basis of a result of the additional machine learning;
transmitting the second model to a specific test apparatus of the plurality of test apparatuses;
recognizing the recognition target using the second model in the specific test apparatus;
determining a recognition result of the recognizing in the specific test apparatus; and
transmitting the second model to at least one of the plurality of test apparatuses in accordance with a determination result by the determining.

13. The image recognition method of claim 12, wherein, in the collecting, image data from which the recognition result of recognizing the recognition target is faulty are collected.

14. The image recognition method of claim 12, wherein in the test apparatus, among the plurality of test apparatuses, to which the second model is transmitted, the model configured to recognize the characteristic portion of the recognition target is updated from the first model to the second model.

15. The image recognition method of claim 12, wherein the plurality of test apparatuses includes a first test apparatus that recognizes the recognition target using the model, which is obtained by previous machine learning and configured to recognize the characteristic portion of the recognition target, and the test apparatus, among the plurality of test apparatuses, to which the second model is transmitted is the first test apparatus.

16. The image recognition method of claim 12, further comprising:
estimating the recognition target for image data from which the recognition target could not be recognized in the test apparatuses; and
transmitting an estimation result of estimating the recognition target to the test apparatus of a transmission source of the image data, and accumulating the image data in the image data collector when the recognition target could not be estimated.

17. The image recognition method of claim 16, wherein the plurality of test apparatuses includes a second test apparatus that does not use the model which is configured to recognize the characteristic portion of the recognition target, and
in the estimating of the recognition target, estimating the recognition target for image data from which the recognition target could not be recognized in the second test apparatus is performed.

18. The image recognition method of claim 16, wherein, in the estimating of the recognition target, estimating the recognition target for the image data by using the first model is performed.

19. The image recognition method of claim 16, wherein the first model, which is configured to be updated to the second model updated in the updating of the model, is used in the estimating of the recognition target.

20. The image recognition method of claim 12, wherein the test apparatuses are configured to perform a test of an electrical characteristic for a wafer on which a plurality of devices are formed by bringing each probe of a probe card into contact with electrode pad of the devices, and
the recognition target is at least one of the electrode pad, needle track formed on the electrode pad by the probe, and needle tip of the probe.
